(19) United States
(12) Patent Application Publication
(10) Pub. No.: US 2020/0136110 A1
(43) Pub. Date: Apr. 30, 2020

(54) BATTERY MODULE

(71) Applicant: SANYO Electric Co., Ltd., Daito-shi, Osaka (JP)

(72) Inventors: Masato Koutari, Hyogo (JP); Naotake Yoshida, Hyogo (JP); Shunsuke Yasui, Hyogo (JP)

(73) Assignee: SANYO Electric Co., Ltd., Daito-shi, Osaka (JP)

(21) Appl. No.: 16/618,514

(22) PCT Filed: May 31, 2018
(86) PCT No.: PCT/JP2018/020879

§ 371 Date: Dec. 2, 2019

(30) Foreign Application Priority Data
Jun. 8, 2017 (JP) 2017-113302

(51) Int. Cl. H01M 2/12; H01M 2/10; H01M 2/26

(52) U.S. Cl. CPC H01M 2/12; H01M 2/26; H01M 2/1077

(57) ABSTRACT

A plurality of battery cells is disposed at a fixed position in a battery holder. Each of the battery cells includes an end surface provided with a discharge port of a discharge valve as an exhaust side end surface, and an end surface opposite to the exhaust side end surface as a non-exhaust side end surface. A discharge duct is connected to the discharge port of the battery cell. Further, a stopper that prevents deformation of the non-exhaust side end surface due to an internal pressure is disposed at a position opposite to the non-exhaust side end surface of the battery cell.

### TECHNICAL FIELD

The present invention relates to a battery module including a battery cell having a discharge valve that is opened when an internal pressure becomes higher than a set value and prevents the internal pressure from rising, and that prevents an exterior case of a battery from being destroyed by an abnormal internal pressure. In particular, the present invention relates to a battery module that normally exhausts high-temperature gas and foreign object from a discharge duct with a discharge valve opened.

### BACKGROUND ART

A battery cell may have an abnormally high internal pressure depending on charge and discharge current values and external conditions during use. Since an abnormal increase in internal pressure causes a battery case to be destroyed, a battery cell having a discharge valve that is opened at a set pressure has been developed to prevent this problem. A battery module including this battery cell is provided with a discharge duct that exhausts, to the outside, high-temperature and high-pressure discharge gas discharged from the discharge valve that has been opened. The discharge duct is connected to an opening portion of the discharge valve, and guides and exhausts, to the outside, the high-temperature and high-pressure discharge gas discharged from the opening portion. (See PTL 1.)

The battery module described above exhausts, to the outside, the discharge gas discharged from the discharge valve, and prevents harmful effects of high-temperature and high-pressure discharge gas being injected into the battery module. However, the battery cell may suffer an abnormally high internal pressure depending on the battery structure and use environment. This may cause destruction of parts other than the discharge valve, and injection of the high-temperature and high-pressure discharge gas. In particular, the battery cell in which an electrode is pressed into the battery case at a significantly high density to increase a charge and discharge capacity causes the high-density electrode to hinder a gas flow in the inside, and causes gas pressures to be ununiform.

Furthermore, in recent years, a battery cell has been developed in which a thin wall portion having a ring shape is locally provided, as a discharge valve, on a bottom surface of an exterior can (see PTL 2).

This battery cell has the discharge valve including the thin wall portion on the bottom surface of the exterior can, which is an end surface opposite to a sealing plate. Thus, when the internal pressure is abnormally high, the battery cell discharges high-temperature and high-pressure discharge gas from the bottom surface of the exterior can but not from the sealing plate. A battery module is assembled such that this battery cell has a structure in which a discharge duct is connected to an opening portion of the discharge valve provided on the bottom surface of the exterior can, and the high-temperature and high-pressure discharge gas discharged from the bottom surface of the exterior can is exhausted to the outside.

### CITATION LIST

### Patent Literature

PTL 1: Unexamined Japanese Patent Publication No. 2014-170613

PTL 2: Unexamined Japanese Patent Publication No. 2017-69184

### SUMMARY OF THE INVENTION

### Technical Problem

The battery module including the discharge duct connected to the opening portion of the discharge valve can normally discharge, to the outside, the high-temperature and high-pressure discharge gas discharged from the discharge valve, which is opened. However, the internal pressure imbalance generated inside the battery cell causes damage to parts other than the discharge valve when the internal pressure rises to the set pressure. For example, a battery module including a battery cell that has a thin wall portion on the bottom surface of an exterior can as the discharge valve, connects the discharge duct to the bottom surface as an “exhaust side end surface” that discharges the discharge gas. However, the sealing plate side, which is an end surface on the opposite side, has no discharge valve and serves as a “non-exhaust side end surface”, and therefore is not provided with the discharge duct. However, when the battery cell suffers an abnormally high internal pressure and the discharge valve provided on the bottom surface side is opened, the sealing plate side, which is the non-exhaust side end surface, may be destroyed and the high-temperature and high-pressure discharge gas may be ejected. In particular, the battery cell has a structure in which the sealing plate is fixed by a caulking structure or laser welding to the opening portion of the exterior can, and a strength equivalent to strength on the bottom surface of the exterior can manufactured by drawing a metal sheet, is hard to achieve. Thus, it is impossible to completely eliminate the damage to the non-exhaust side end surface, which is the sealing plate side, when the internal pressure is abnormally high. In particular, in a battery cell in which the internal electrode density is extremely increased in order to increase the charge and discharge capacity, an internal pressure imbalance also causes damage to the non-exhaust side end surface.

Since the battery module connects the discharge duct to the exhaust side end surface, the discharge gas discharged from the exhaust side end surface can be exhausted to the outside of the battery module by the discharge duct. However, since the discharge duct is not disposed on the non-exhaust side end surface, the discharge gas discharged from the non-exhaust side end surface cannot be discharged to the outside. Therefore, when the non-exhaust side end surface is destroyed, the high-temperature and high-pressure discharge gas is injected into the battery module, causing a significant reduction in safety.

The present invention has been accomplished to solve the above problems. An important object of the present invention is to provide a battery module that, with a simple structure, achieves high safety by reliably preventing injection of high-temperature and high-pressure discharge gas from a non-exhaust side end surface of a battery cell without changing a structure of the battery cell.

### Solution to Problem and Advantageous Effects of Invention

A battery module of the present invention includes a plurality of battery cells, a battery holder, and an exhaust duct. Each of the battery cells has an end surface, as an exhaust side end surface, provided with a discharge port of a discharge valve that is opened when an internal pressure exceeds a set pressure, and an end surface opposite to the exhaust side end surface as a non-exhaust side end surface. The battery holder has each of the battery cells disposed at a fixed position. The exhaust duct is connected to the discharge port of each of the battery cells disposed at the fixed position in the battery holder. Further, in the battery module, a stopper that prevents deformation of the non-exhaust side end surface due to the internal pressure is disposed at a position opposite to the non-exhaust side end surface of each of the battery cells.

The battery module described above achieves high safety, with a simple structure, by reliably preventing injection of high-temperature and high-pressure discharge gas from the non-exhaust side end surface of the battery cell without changing a structure of the battery cell. This is because the battery module presses the non-exhaust side end surface of the battery cell by the stopper and prevents the non-exhaust side end surface from being deformed by the internal pressure. In particular, the battery module described above prevents destruction of the non-exhaust side end surface by an extremely simple structure in which the stopper is disposed at a position opposite to the non-exhaust side end surface of the battery cell without changing the structure of the battery cell itself. When the internal pressure rises abnormally, the discharge valve is opened and high-temperature and high-pressure discharge gas is discharged only from the exhaust side end surface. This achieves safe discharge to the outside of the battery module by using the discharge duct. The above features are particularly important in high-quality battery cells in which a packing density of the electrodes is high to increase the charge and discharge capacity. In a battery cell having a high packing density, the high-density electrode impedes the free flow of gas and causes an internal pressure imbalance. With the internal pressure imbalance, the internal pressures of the exhaust side end surface and the non-exhaust side end surface may not be the same, and the internal pressure of the non-exhaust side end surface may be increased. However, even in this state, the deformation of the non-exhaust side end surface is prevented by the stopper, and the destruction of the non-exhaust side end surface is reliably prevented. In addition, in high capacity battery cells, an exterior can is made as thin as possible to increase the charge and discharge capacity per unit weight and unit volume. This requires the exterior can of the high-quality battery cells to be thinner, making it difficult to increase the strength of the non-exhaust side end surface, that is, the destruction pressure. The non-exhaust side end surface is thus easily destroyed when the internal pressure rises. However, since the above battery module can reliably prevent the destruction of the non-exhaust side end surface of the battery cell by the stopper, even in high-quality battery cells, the high-temperature and high-pressure discharge gas can be safely exhausted from the discharge duct to the outside by reliably opening the discharge valve without destroying the non-exhaust side end surface when the internal pressure rises abnormally.

The battery cell of the battery module according to an aspect of the present invention includes an exterior can that is opened at one end and closed at a bottom surface, and a sealing plate that is hermetically connected to an opening edge of the exterior can to seal an opening portion, and is provided with an electrode terminal. A discharge valve that destroys a thin wall portion with a set pressure is provided on the bottom surface of the exterior can of the battery cell. A bottom surface of the battery cell can be an exhaust side end surface, and a sealing plate side of the battery cell can be a non-exhaust side end surface.

The battery module described above has the sealing plate side provided with the electrode terminal as the non-exhaust side end surface, and the thin wall portion on the bottom surface of the exterior can as the discharge valve. Thus, the high-temperature and high-pressure discharge gas can be quickly exhausted from the discharge valve that has an enlarged opening area to be opened. Furthermore, since the stopper is disposed on the sealing plate side as the non-exhaust side end surface, it is possible to enhance safety by reliably preventing the destruction on the sealing plate side, for which it is difficult to achieve high strength in terms of the structure compared with the bottom surface. In particular, the battery case including the exterior can and the sealing plate is required to be thin in order to increase the capacity. This causes a decrease in breaking strength on the sealing plate side. However, in the battery module described above, the stopper prevents the destruction on the sealing plate side. Therefore, the battery module using the high-quality battery cell with the high capacity ensures high safety.

In the battery module according to an aspect of the present invention, the battery cell can be a cylindrical battery. This battery module achieves the increased charge and discharge capacity with respect to the volume of the battery cell. At the same time, the battery module achieves high safety by reliably preventing, by the stopper, the breakage on the sealing plate side, which has a difficulty in achieving high strength compared with the bottom surface of the exterior can. A cylindrical battery can have a larger charge and discharge capacity than a prismatic battery in terms of the shape because positive and negative electrode plates laminated via a separator are spirally wound into a columnar electrode, which is inserted into the exterior can having a cylindrical shape and assembled. When the positive and negative electrode plates that have been laminated are spirally wound into the columnar electrode, the electrode has a high electrode density in a winding process. Further, the columnar electrode is inserted into the exterior can having the cylindrical shape. The electrode is inserted at a high density and assembled, and the charge and discharge capacity is thus increased. However, the cylindrical battery is connected by caulking an opening edge of the exterior can and the sealing plate, it is difficult to make strength on the sealing plate side equivalent to strength on the bottom surface of the exterior can. This causes the sealing plate side to be easily destroyed due to an abnormal internal pressure. However, in the battery module described above, the stopper reliably prevents the destruction caused by the internal pressure on the sealing plate side, which has a difficulty in enhancing the strength compared with the bottom surface side. Therefore, the battery module achieves high capacity by using the cylindrical battery, and at the same time, achieves high safety by preventing the destruction on the sealing plate side.

The stopper of the battery module according to an aspect of the present invention can have a structure to press the sealing plate. Furthermore, the stopper can have a structure to press a flat portion of the sealing plate, or press a protruding electrode of the sealing plate, and also press a caulking portion.

In the battery module according to an aspect of the present invention, the stopper can be an insulating material. Further, the battery module according to an aspect of the present invention has a structure in which a bus bar that is opposite to the exhaust side end surface of the battery cell and is connected to the electrode terminal of the battery cell is provided, and the bus bar presses the non-exhaust side end surface via the stopper.

The battery module according to an aspect of the present invention can have a structure in which the stopper is molded integrally with the battery holder.

Further, the battery module according to an aspect of the present invention has a structure including a housing in which the battery holder is disposed inside, and the housing presses the stopper against the non-exhaust side end surface directly or via any one of or both of the battery holder and the bus bar.

### BRIEF DESCRIPTION OF DRAWINGS

FIG. 1 is a schematic cross-sectional view of a battery module according to an example of the present invention.

FIG. 2 is an enlarged schematic cross-sectional view of a battery module according to another example of the present invention.

FIG. 3 is an enlarged schematic cross-sectional view of a battery module according to still another example of the present invention.

FIG. 4 is an enlarged schematic cross-sectional view of a battery module according to yet another example of the present invention.

FIG. 5 is an enlarged schematic cross-sectional view of a battery module according to further example of the present invention.

FIG. 6 is an enlarged schematic cross-sectional view of a battery module according to still further example of the present invention.

FIG. 7 is a perspective view of a stopper of the battery module shown in FIG. 6.

FIG. 8 is a schematic cross-sectional view of a battery module according to yet further example of the present invention.

FIG. 9 is a perspective view of a stopper of the battery module shown in FIG. 8.

FIG. 10 is a partially enlarged cross-sectional view of connection of the stopper of the battery module shown in FIG. 8.

### DESCRIPTION OF EMBODIMENT

Hereinafter, an exemplary embodiment of the present invention will be described with reference to the drawings. However, the exemplary embodiment described below exemplifies a configuration that embodies the technical idea of the present invention, and the present invention is not limited to the following. Further, the components recited in the claims are not limited to the components described in the exemplary embodiment. In particular, it is not intended to limit the scope of the present invention to sizes, materials, shapes, relative arrangement, and the like of the components, which are described in the exemplary embodiment, unless otherwise specified. The sizes and the like are mere explanation examples. Note that the sizes, the positional relation, and the like of the components in each drawing may be exaggerated for clarifying the explanation. Furthermore, in the following description, the same names or the same reference marks denote the same components or the same types of components, and detailed description is therefore appropriately omitted. Regarding the elements configuring the present invention, a plurality of elements may be made up of the same component, and one component may serve as the plurality of elements. To the contrary, the function of one component may be shared by the plurality of components. In addition, the contents described in some examples and exemplary embodiment may be used in other examples, exemplary embodiment, and the like.

A battery module described below is mainly described as an example applied to a power source for driving an electric vehicle, such as a hybrid vehicle that travels by both an engine and a motor, and an electric vehicle that travels only by a motor. The battery module of the present invention may be used for vehicles other than hybrid vehicles and electric vehicles, or for applications requiring high output other than electric vehicles, such as household and factory power storage devices.

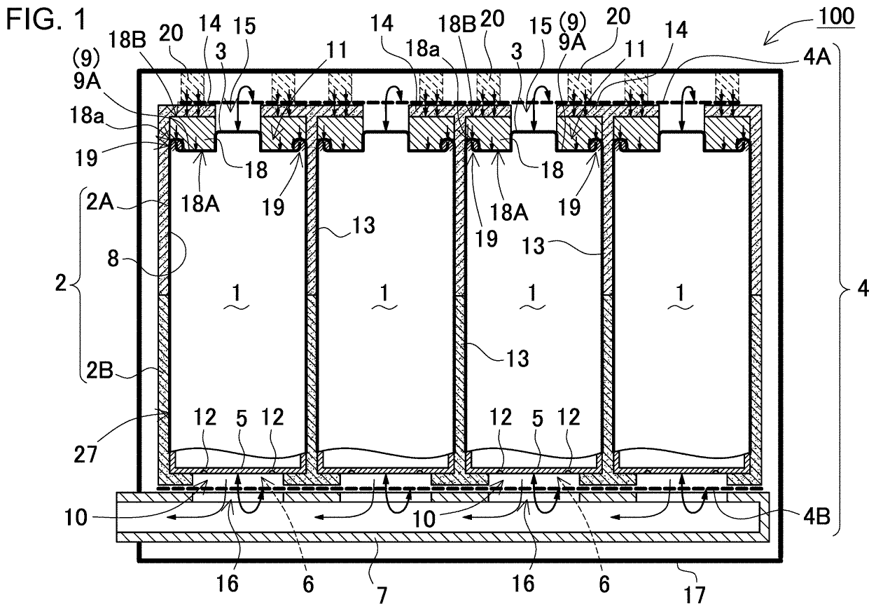

FIGS. 1 to 8 are cross-sectional views of the battery module according to the exemplary embodiment. Battery module 100 shown in the drawings includes a plurality of battery cells 1, battery holder 2 in which each of battery cells 1 is disposed at a fixed position, bus bar 4 that is a metal sheet connected to positive and negative electrode terminals of battery cell 1 disposed at the fixed position in battery holder 2, discharge duct 7 connected to discharge port 6 of discharge valve 5 provided on battery cell 1, and housing 17 in which all the above components are disposed at fixed positions inside.

Battery cell 1 is a cylindrical battery of a lithium ion secondary battery. However, in the present invention, battery cell 1 is not limited to a lithium ion secondary battery, but may be any other chargeable batteries, for example, a non-aqueous electrolyte battery other than a lithium ion secondary battery, or other batteries. In the cylindrical battery of battery cell 1, an opening portion of exterior can 8 having a cylindrical shape and closing a bottom is hermetically sealed with sealing plate 9. Exterior can 8 is manufactured by deep-drawing a metal sheet. Sealing plate 9 has a disc shape and is provided with protruding electrode 3 in a center. Sealing plate 9 is insulated from an opening edge of exterior can 8 by a caulking structure via an insulating material and fixed to an airtight structure.

Battery cell 1 is provided with discharge valve 5 on a bottom surface of exterior can 8. Discharge valve 5 is opened when an internal pressure of battery cell 1 becomes higher than a set pressure, and exhausts internal gas to the outside to prevent a battery case from being destroyed. The increase in the internal pressure of battery cell 1 occurs under severe conditions, such as battery overcharge, overdischarge, excessive current, physical shock, external short circuit, and abnormally high temperature. Battery cell 1 prevents the battery case from bursting by opening discharge valve 5 in a state where the internal pressure is abnormally high.

Discharge valve 5 is provided on one end surface of battery cell 1. In battery cell 1 shown in the drawings, discharge valve 5 is provided on the bottom surface of exterior can 8, and discharge valve 5 is not provided on the side of sealing plate 9. The bottom surface provided with discharge valve 5 is exhaust side end surface 10 that discharges discharge gas. An upper end surface without discharge valve 5 is non-exhaust side end surface 11 and does not discharge the discharge gas.

Battery cell 1 shown in the drawings is provided with thin wall portion 12 in a ring shape on the bottom surface of exterior can 8 to serve as discharge valve 5. Discharge valve 5 having this structure controls the set pressure for opening discharge valve 5 by adjusting a thickness of thin wall portion 12. The set pressure for opening discharge valve 5 is lowered by thinning thin wall portion 12, and the set pressure for opening the discharge valve 5 is increased by increasing the thickness. When the internal pressure of the battery becomes higher than the set pressure, thin wall portion 12 is broken, and discharge valve 5 is opened. In discharge valve 5 configured by thin wall portion 12 having a ring shape, thin wall portion 12 is broken when the valve is opened, and thus discharge port 6 is opened inside of thin wall portion 12.

Battery holder 2 is manufactured by molding a resin, such as a thermoplastic resin, which is an insulating material. Battery holder 2 may be preferably made of a resin excellent in flame-resistance and heat-resistance. As such a resin, for example, polycarbonate (PC), polypropylene (PP), nylon, and the like can be used.

In battery holder 2 shown in the drawings, battery cell 1 is disposed in battery storage portion 27 and disposed at the fixed position. Battery holder 2 shown in the drawings has a plurality of battery cells 1 in parallel in such a way that both end surfaces are disposed on substantially same planes. Further, in battery holder 2, each of battery cells 1 is disposed at a position where discharge port 6 of discharge valve 5 is connected to discharge duct 7. Battery holder 2 has a plurality of battery storage portions 27, and battery cell 1 is disposed in each of battery storage portions 27. Battery storage portion 27 has an inner shape in which battery cell 1 can be disposed, and battery cell 1 is inserted and disposed at the fixed position. Battery holder 2 has partition wall 13 between battery storage portions 27. Battery storage portions 27 are provided on both sides of partition wall 13, and battery cells 1 are insulated and disposed at these positions. Furthermore, each of battery storage portions 27 is provided with flat plate portion 14 having opening portions at both ends.

Flat plate portion 14 of battery holder 2 in FIG. 1 is provided with connection opening 15 that connects positive and negative electrode terminals to bus bar 4. Battery holder 2 shown in the drawing is divided at a center of battery cell 1 in a longitudinal direction in the drawings into upper and lower holder units 2A, 2B. Battery cell 1 is inserted inside holder units 2A, 2B, in a state where holder units 2A, 2B are vertically divided. Then, holder units 2A, 2B are connected, and battery cell 1 is disposed at the fixed position. In battery holder 2, connection opening 15 of flat plate portion 14 is smaller than an outer shape of battery cell 1, and battery cell 1 is disposed so as not to move from battery storage portion 27 to the outside. However, the battery holder can have a structure in which an opening portion having a shape into which the battery cell can be inserted is provided at a lower end, and the battery cell can be inserted from the opening portion at the lower end to be disposed at the fixed position.

Bus bar 4 is a metal sheet, and is connected to the positive and negative electrode terminals of battery cell 1 directly or via a lead plate indicated by an arrow. Bus bar 4 connects battery cells 1 that are adjacent to each other in parallel or in series. In battery module 100 shown in the drawing, battery cells 1 that are adjacent to each other are connected in parallel. Battery cells 1 that are connected in parallel have a positive electrode connected by first bus bar 4A and a negative electrode connected by second bus bar 4B. In battery module 100, a current capacity can be increased by connecting battery cells 1 in parallel. In battery module 100, an output voltage can be increased by connecting battery cells 1 in series. In the battery module in which the battery cells are connected in series, the positive and negative electrodes of battery cells that are adjacent to each other are connected by bus bar 4.

Battery cell 1 of a cylindrical battery uses protruding electrode 3 of sealing plate 9 and the bottom surface of exterior can 8 as positive and negative electrode terminals, respectively. Protruding electrode 3 and the bottom surface of exterior can 8 are connected to first bus bar 4A and second bus bar 4B, respectively. In battery module 100 shown in the drawing, first bus bar 4A and second bus bar 4B are disposed at fixed positions on a surface of flat plate portion 14 of battery holder 2. Although not shown, the battery holder can be provided with a fitting recess that houses each of the bus bars in the flat plate portion to dispose the bus bar at the fixed position. Thus, the bus bar can be disposed at the fixed position. Bus bar 4 is connected to the electrode terminal of battery cell 1 directly or via a lead plate by a method such as laser welding, spot welding, or ultrasonic welding.

Discharge duct 7 exhausts high-temperature and high-pressure discharge gas discharged from discharge valve 5 of battery cell 1, to the outside of housing 17. Discharge duct 7 is disposed to be connected to discharge port 6 of discharge valve 5 provided on exhaust side end surface 10 of battery cell 1, and exhausts the discharge gas discharged from discharge valve 5, to the outside. Discharge duct 7 has a plurality of opening windows 16 connected to discharge ports 6 of discharge valves 5 of battery cells 1, and a tip of discharge duct 7 is disposed outside of housing 17.

Housing 17 is a metal case, and battery holder 2, bus bar 4, and discharge duct 7 are disposed at the fixed positions in housing 17. Battery holder 2 in which battery cell 1 is disposed at the fixed position, bus bar 4 connected to battery cell 1, and discharge duct 7 disposed on exhaust side end surface 10 are connected in an integrated structure, assembled as a battery unit, and fixed at the fixed position in housing 17. Bus bar 4 is connected to battery cell 1 and is disposed at the fixed position in battery holder 2 with a fitting structure with battery holder 2. Although not shown, discharge duct 7 is fixed to battery holder 2 and disposed at the fixed position. In housing 17, the battery unit is fixed at the fixed position inside by screwing, a fitting structure, a sandwiching structure, or the like and disposed. Bus bar 4 made of metal and housing 17 made of metal are disposed so as to be insulated from each other. Insulation between bus bar 4 and housing 17 is achieved by providing a gap and arranging an insulating material, or arranging a component including an insulating material, such as discharge duct 7.

Battery module 100 includes stopper 18 that prevents non-exhaust side end surface 11 from being deformed and broken by the internal pressure. Stopper 18 presses non-exhaust side end surface 11 so as not to deform non-exhaust side end surface 11, and prevents non-exhaust side end surface 11 from being destroyed. Stopper 18 is located in a position opposite to non-exhaust side end surface 11 of battery cell 1, and presses non-exhaust side end surface 11. Stopper 18 has pressing portion 18A at a tip and fixing portion 18B at back. Pressing portion 18A presses flat portion 9A of sealing plate 9 or protruding electrode 3 or presses caulking portion 19 of sealing plate 9 to prevent breakage of non-exhaust side end surface 11 due to the internal pressure. Fixing portion 18B is supported with bus bar 4, battery holder 2, housing 17, or the like, such that stopper 18 does not move due to a reaction of pressing portion 18A pressing non-exhaust side end surface 11.

Stopper 18 in FIGS. 1 to 4 presses flat portion 9A of sealing plate 9 and caulking portion 19 on non-exhaust side end surface 11 of battery cell 1 by pressing portion 18A. Stopper 18 in FIGS. 1 to 4 presses flat portion 9A of sealing plate 9 and caulking portion 19 with pressing portion 18A, and ideally prevents the deformation and destruction of non-exhaust side end surface 11. Alternatively, stopper 18 may have a shape in which only flat portion 9A is pressed by pressing portion 18A or only caulking portion 19 is pressed by pressing portion 18A.

Stopper 18 shown in the above-referenced drawings is disposed between bus bar 4 and sealing plate 9 on non-exhaust side end surface 11. As shown by the arrows in FIG. 1, stopper 18 has fixing portion 18B disposed inside of flat plate portion 14 of battery holder 2. In battery holder 2 shown in the drawing, connecting portion 20 indicated by chain lines is provided between flat plate portion 14 and housing 17. Connecting portion 20 has a shape protruding inside from an inner surface of housing 17, and a protruding height that closes a gap between flat plate portion 14 and housing 17. Connecting portion 20 is provided by being molded integrally with battery holder 2 made of an insulating material. Flat plate portion 14 that is supported by connecting portion 20 and prevented from being deformed is not deformed by being pressed by stopper 18. Stopper 18 reliably prevents deformation and destruction of non-exhaust side end surface 11. In battery holder 2 shown in the drawing, bus bar 4 made of a metal sheet is disposed outside of flat plate portion 14. Battery holder 2 having this structure uses a thick metal sheet for bus bar 4 and connects bus bar 4 to the outer surface of flat plate portion 14 by a fitting structure or the like. Thus, flat plate portion 14 is reinforced by bus bar 4. Since bus bar 4 prevents battery holder 2 from being deformed, housing 17 does not press flat plate portion 14, and flat plate portion 14 supports fixing portion 18B of stopper 18 so as not to move fixing portion 18B.

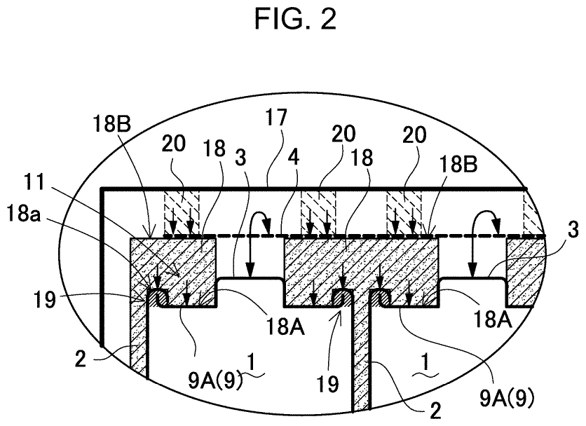

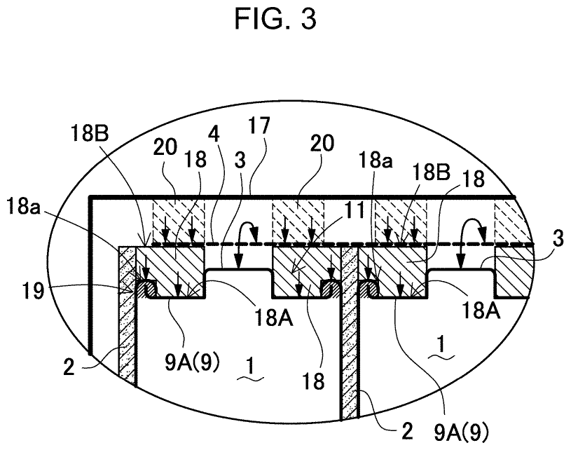

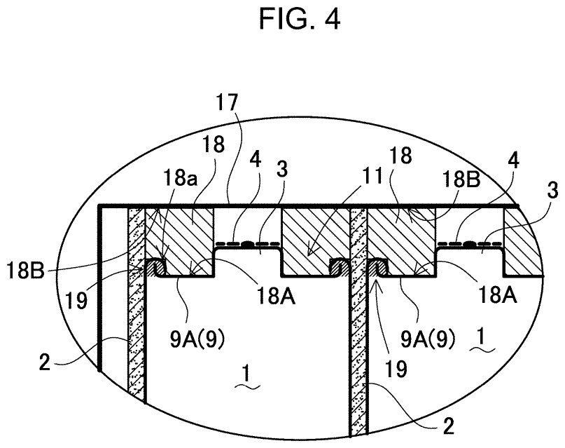

In battery module 100 shown in FIG. 1, stopper 18 is a separate member from battery holder 2. Stopper 18 is made of an insulating material, such as plastic. In battery module 100 shown in FIG. 2, stopper 18 is integrated with battery holder 2. Stopper 18 is provided integrally with battery holder 2 by molding. Stopper 18 integrated with battery holder 2 is disposed at a fixed position without any misalignment. Since in stopper 18 integrated with battery holder 2, an upper surface is fixing portion 18B in the drawing, fixing portion 18B is supported by bus bar 4 and housing 17, and stopper 18 does not move by being pressed by non-exhaust side end surface 11. In battery module 100 shown in FIG. 3, stopper 18 is disposed between non-exhaust side end surface 11 and bus bar 4. Stopper 18 connects fixing portion 18B to bus bar 4 and supports stopper 18 in the fixed position via bus bar 4. In this structure, a thick metal sheet is used for bus bar 4 to support fixing portion 18B with strong bus bar 4 that is not deformed, such that fixing portion 18B does not move. Alternatively, as shown by chain lines in the drawing, connecting portion 20 of an insulating material is provided between stopper 18 and housing 17. Thus, connecting portion 20 prevents bus bar 4 from being deformed. In this structure, connecting portion 20 supported by housing 17 prevents bus bar 4 from being deformed, and bus bar 4 supports stopper 18 so as not to move stopper 18. In battery module 100 shown in FIG. 4, stopper 18 is disposed between non-exhaust side end surface 11 and housing 17. Stopper 18 connects fixing portion 18B to housing 17 made of strong metal, and reliably prevents deformation. Bus bar 4 is wired between stoppers 18 and is connected to protruding electrode 3.

Stopper 18 is made of an insulating material, such as plastic. Stopper 18 shown in FIGS. 1 to 3 has a cylindrical shape having an inner diameter substantially equal to an outer diameter of protruding electrode 3, and cutout 18a that guides caulking portion 19 is provided on an outer peripheral portion of a tip. Stopper 18 is disposed at a fixed position by inserting protruding electrode 3 inside of stopper 18 and inserting caulking portion 19 into cutout 18a. Stopper 18 shown in FIG. 4 has a shape in which a cylinder is divided on both sides of protruding electrode 3. Bus bar 4 is disposed between stoppers 18 on both sides, and bus bar 4 is connected to protruding electrode 3.

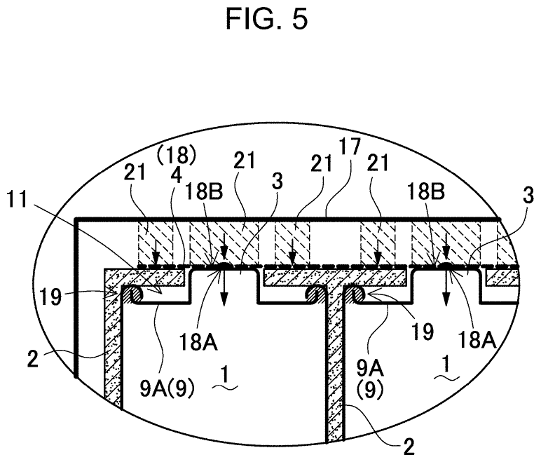

Stopper 18 shown in FIGS. 5, 6, and 8 presses protruding electrode 3 of sealing plate 9. Battery module 100 shown in FIG. 5 uses bus bar 4 also as stopper 18. Bus bar 4 presses protruding electrode 3 to prevent destruction due to deformation of non-exhaust side end surface 11. Stopper 18 of bus bar 4 presses protruding electrode 3 using a connecting portion of protruding electrode 3 as pressing portion 18A. Stopper 18 is connected to a member that supports fixing portion 18B, and prevents movement due to a reaction of pressing protruding electrode 3. Fixing portion 18B is connected to battery holder 2 to prevent misalignment of stopper 18 of bus bar 4. As shown by chain lines, fixing portion 18B is connected to supporting portion 21 provided between bus bar 4 and housing 17 to prevent the misalignment. Alternatively, fixing portion 18B is connected bus bar 4 pressed against battery holder 2 by supporting portion 21 to prevent the misalignment. Supporting portion 21 provided between housing 17 and bus bar 4 is manufactured by molding an insulating material, such as plastic. Supporting portion 21 made of an insulating material is integrated with battery holder 2 or is fixed at a fixed position on the inner surface of housing 17 by a method such as adhesion.

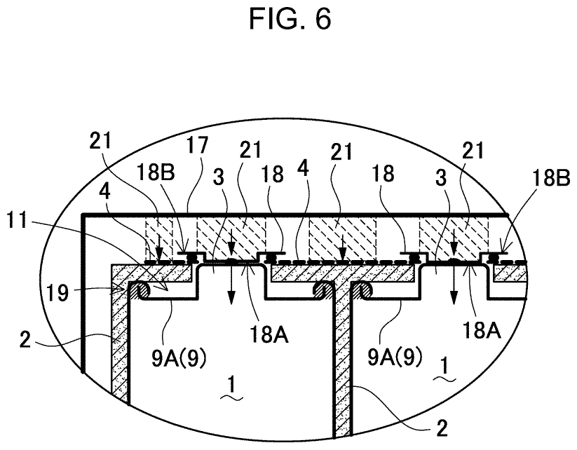

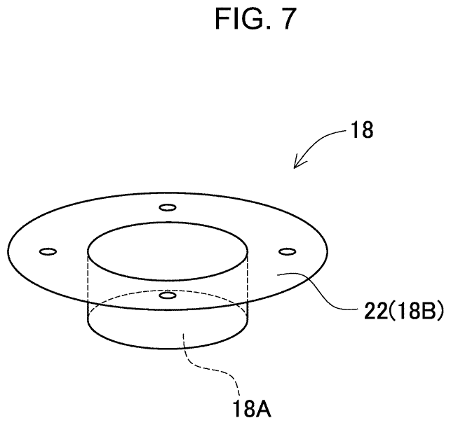

Stopper 18 shown in FIG. 6 is a connection metal fitting connected to bus bar 4. Stopper 18 is used also as the lead plate to connect bus bar 4 to protruding electrode 3. A perspective view of FIG. 7 shows stopper 18 of the connection metal fitting. Stopper 18 is manufactured by pressing a metal sheet into a cylindrical shape with a bottom closed and flange 22 provided on an opening edge. Flange 22 is fixed to a surface of bus bar 4. The bottom is welded to protruding electrode 3 and fixed to non-exhaust side end surface 11. Stopper 18 has a bottom that is fixed to protruding electrode 3 as pressing portion 18A and flange 22 that is connected to bus bar 4 as fixing portion 18B. Stopper 18 is fixed at the fixed position via bus bar 4, or is disposed at the fixed position via supporting portion 21 provided between stopper 18 and housing 17. Bus bar 4 with which stopper 18 is disposed at the fixed position is fixed to battery holder 2 and disposed at the fixed position. In a structure in which supporting portion 21 shown by the chain lines in FIG. 6 is disposed between bus bar 4 and housing 17, bus bar 4 is disposed at the fixed position so as not to cause misalignment. Stopper 18 of the connection metal fitting is disposed at the fixed position. This prevents deformation and breakage of non-exhaust side end surface 11.

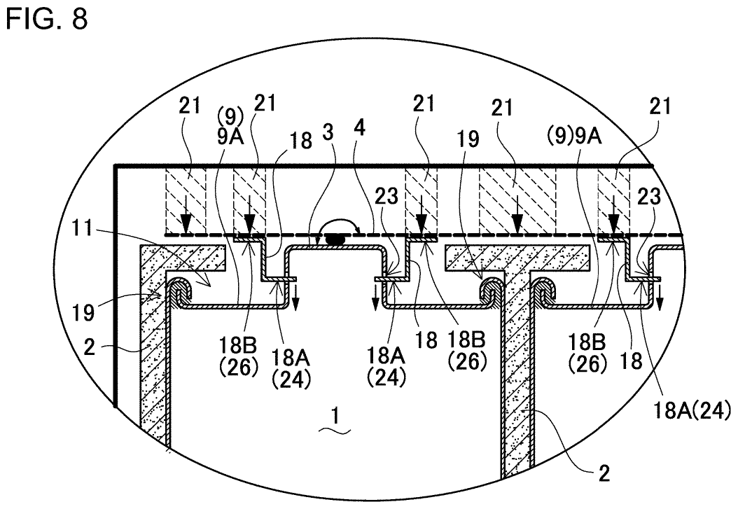

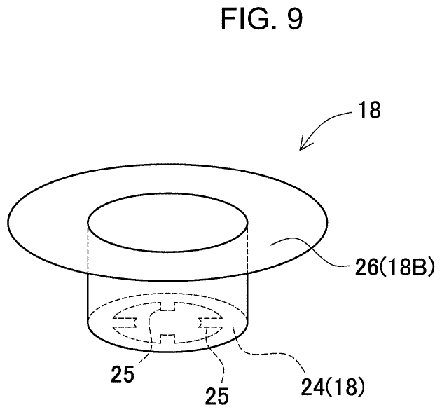

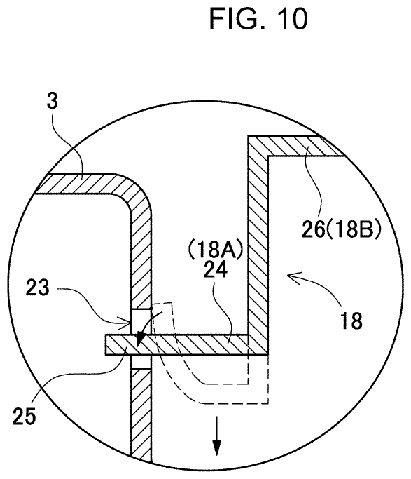

Battery module 100 shown in FIG. 8 is a locking metal fitting in which stopper 18 is connected to through hole 23 of protruding electrode 3. Stopper 18 is manufactured by pressing a metal sheet that is elastically deformed. Stopper 18 of the locking metal fitting is shown in the perspective view of FIG. 9. Stopper 18 is provided with locking plate 24 of pressing portion 18A on the bottom surface of a cylindrical portion, and flange 26 of fixing portion 18B on an upper end edge. Locking plate 24 on the bottom has a ring shape and is provided inside with locking projection 25 to be inserted into through hole 23 on a side surface of protruding electrode 3. A height of the cylindrical portion is a dimension in which flange 26 is brought into contact with a lower surface of bus bar 4 and locking projection 25 is inserted into through hole 23 of protruding electrode 3. In stopper 18, protruding electrode 3 is inserted into a center hole of locking plate 24, and locking projection 25 is elastically deformed and inserted into through hole 23 of protruding electrode 3 as shown in FIG. 10. Stopper 18 is disposed at the fixed position via bus bar 4 without misalignment, and bus bar 4 is disposed at the fixed position by battery holder 2. Bus bar 4 is pressed by supporting portion 21 to be disposed at the fixed position. Stopper 18 is thus disposed at the fixed position. Supporting portion 21 is disposed between bus bar 4 and housing 17 as shown by chain lines in the drawing. In particular, supporting portion 21 is disposed in a portion where flange 26 of the locking metal fitting is disposed on a back surface, and stopper 18 is disposed so as to minimize misalignment.

### INDUSTRIAL APPLICABILITY

A battery module of the present invention can be effectively used for a power source module having a structure in which high-temperature and high-pressure discharge gas is discharged from an exhaust side end surface when an internal pressure of a battery cell is increased.

### REFERENCE MARKS IN THE DRAWINGS

100: battery module
1: battery cell
2: battery holder
2A, 2B: holder unit
3: protruding electrode
4: bus bar
4A: first bus bar
4B: second bus bar
5: discharge valve
6: discharge port
7: discharge duct
8: exterior can
9: sealing plate
9A: flat portion
10: exhaust side end surface
11: non-exhaust side end surface
12: thin wall portion
13: partition wall
14: flat plate portion
15: connection opening
16: opening window
17: housing
18: stopper
18A: pressing portion
18B: fixing portion
18a: cutout
19: caulking portion
20: connecting portion
21: supporting portion
22: flange
23: through hole
24: locking plate
25: locking projection
26: flange
27: battery storage portion

1. A battery module comprising:
a plurality of battery cells each including an end surface, as an exhaust side end surface, provided with a discharge port of a discharge valve that is opened when an internal pressure exceeds a set pressure, and an end surface opposite to the exhaust side end surface as a non-exhaust side end surface;
a battery holder having each of the battery cells arranged at a fixed position; and
an exhaust duct connected to the discharge port of each of the battery cells disposed at the fixed position in the battery holder,
wherein a stopper that prevents deformation of the non-exhaust side end surface due to the internal pressure is disposed at a position opposite to the non-exhaust side end surface of each of the battery cells.

2. The battery module according to claim 1, wherein each of the battery cells includes:
an exterior can that is opened at one end and closed at a bottom surface; and
a sealing plate that is hermetically connected to an opening edge of the exterior can to seal an opening portion, and is provided with an electrode terminal,
each of the battery cells is provided, on the bottom surface of the exterior can, with the discharge valve that destroys a thin wall portion with a set pressure, and
each of the battery cells includes a bottom surface as the exhaust side end surface, and a side of the sealing plate as the non-exhaust side end surface.

3. The battery module according to claim 2, wherein each of the battery cells is a cylindrical battery.

4. The battery module according to claim 2, wherein the stopper presses the sealing plate.

5. The battery module according to claim 4, wherein the stopper presses a flat portion of the sealing plate.

6. The battery module according to claim 2, wherein the stopper presses a protruding electrode that is provided on the sealing plate.

7. The battery module according to claim 2, wherein the stopper presses a caulking portion on an outer peripheral edge of the sealing plate.

8. The battery module according to claim 1, wherein the stopper is an insulating material.

9. The battery module according to claim 1, comprising a bus bar that is opposite to the exhaust side end surface and connects the electrode terminal of each of the battery cells,
wherein the bus bar presses the non-exhaust side end surface via the stopper.

10. The battery module according to claim 1, wherein the stopper is molded integrally with the battery holder.

11. The battery module according to claim 1, comprising a housing that arranges the battery holder inside,
wherein the housing presses the stopper to the non-exhaust side end surface directly or via one of or both of the battery holder and the bus bar.

12. The battery module according to claim 2, wherein the stopper is an insulating material.

13. The battery module according to claim 2, comprising a bus bar that is opposite to the exhaust side end surface and connects the electrode terminal of each of the battery cells,
wherein the bus bar presses the non-exhaust side end surface via the stopper.

14. The battery module according to claim 2, wherein the stopper is molded integrally with the battery holder.

15. The battery module according to claim 2, comprising a housing that arranges the battery holder inside,
wherein the housing presses the stopper to the non-exhaust side end surface directly or via one of or both of the battery holder and the bus bar.
